(19) United States
(12) Patent Application Publication
(10) Pub. No.: US 2011/0246530 A1
(43) Pub. Date: Oct. 6, 2011

(54) Method and System for Semantically Unifying Data

(76) Inventor: Geoffrey Malafsky, Burke, VA (US)

(21) Appl. No.: 12/751,725

(22) Filed: Mar. 31, 2010

(51) Int. Cl. G06F 17/30

(52) U.S. Cl. 707/794; 707/E17.044

(57) ABSTRACT

A method and system For Semantically Unifying Data from multiple disparate sources into a common semantic framework. The method and system For Semantically Unifying Data generally includes a data unification system containing a computer, server, network connection, stored data files, and software logic to allow a user to edit and manage key data integration and data quality information; a semantic framework containing a domain's concepts and data definitions; rule dictionaries containing business and technical rules; data dictionaries containing data models and specifications; an object metadata schema containing semantic metadata; and, ontology templates defining object classes for machine readable data concepts.

### BACKGROUND OF THE INVENTION

The present invention relates generally to data management and more specifically it relates to a method and system for semantically unifying data from multiple disparate sources into a common semantic framework.

### BRIEF SUMMARY OF THE INVENTION

The invention generally relates to data management which includes: a data unification system containing a computer, server, network connection, stored data files, and software logic to allow a user to edit and manage key data integration and data quality information; a semantic framework containing a domain's concepts and data definitions; rule dictionaries containing business and technical rules; data dictionaries containing data models and specifications; an object metadata schema containing semantic metadata; and, ontology templates defining object classes for machine readable data concepts.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a Method And System For Semantically Unifying Data from multiple disparate sources into a common semantic framework by integrating the domain's key knowledge, ontological concepts, business and technical rules, and semantic metadata.

Another object is to provide a Method And System For Semantically Unifying Data that unifies the definitions, formats, values, and meaning of data from multiple sources pertaining to the same concept into a single common specification of definition, format, value, and meaning.

Another object is to provide a Method And System For Semantically Unifying Data that maintains the original definitions, formats, values, and meaning of data from multiple sources pertaining to the same concept.

Another object is to provide a Method And System For Semantically Unifying Data that uses business and technical rules to represent the domain's knowledge and ontologies in a structured form.

Another object is to provide a Method And System For Semantically Unifying Data that uses semantic metadata to represent the domain's knowledge, ontology concepts, and business and technical rules in a structured form to annotate data objects.

Another object is to provide a Method And System For Semantically Unifying Data that provides an intuitive user display of business and technical rules and enables a user to edit and manage the rules in data files.

Another object is to provide a Method And System For Semantically Unifying Data that provides an intuitive user display of semantic metadata and enables a user to edit and manage the semantic metadata in data files.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the overall of the present invention. Data unification system architecture.

FIG. 2 is a block diagram illustrating a sub-component of the present invention. Definition of the semantic framework integrating a domain's knowledge, ontologies, rules, and semantics showing the relationship between each layer.

FIG. 3 is a block diagram illustrating a sub-component of the present invention. Definition of the rule dictionary schema.

FIG. 4 is comprised of FIGS. 4A and 4B. FIG. 4A is a block diagram illustrating a sub-component of the present invention. Definition of the data dictionary schema Class and ClassElement. FIG. 4B is a block diagram illustrating a sub-component of the present invention. Definition of the data dictionary schema MainTable.

FIG. 5 is a block diagram illustrating a sub-component of the present invention. Definition of the object metadata schema.

FIG. 6 is comprised of FIGS. 6A, 6B, 6C, and 6D. FIG. 6A is a block diagram illustrating a sub-component of the present invention. Ontology layer of the semantic framework showing the sub-ontologies Organization, Process, and Technology along with the primary relationship between items. FIG. 6B is a block diagram illustrating a sub-component of the present invention. Detailed classes in the Organization sub-ontology that form the template used to map a domain's knowledge into the semantic framework. FIG. 6C is a block diagram illustrating a sub-component of the present invention. Detailed classes in the Process sub-ontology that form the template used to map a domain's knowledge into the semantic framework. FIG. 6D is a block diagram illustrating a sub-component of the present invention. Detailed classes in the Technology sub-ontology that form the template used to map a domain's knowledge into the semantic framework.

FIG. 7 is a flowchart illustrating a sub-operation of the present invention. Data unification system operations to edit, manage, and store products.

FIG. 8 is a flowchart illustrating a sub-operation of the present invention. Semantic analysis process.

### DETAILED DESCRIPTION OF THE INVENTION

### A. Overview

Turning now descriptively to the drawings, in which similar reference characters denote similar elements throughout the several views, the figures illustrate: a computer containing a display and software logic allowing a user to edit and manage key data integration and data quality information; a server containing software logic to process data and enforce access control security; a network connection allowing electronic communication between the computer and server; a storage device for data files and a database; a semantic framework containing a domain's concepts and data definitions structured in integrated knowledge, ontologies, rules, and semantic metadata; rule dictionaries containing structured domain business and technical rules; data dictionaries containing structured domain data models and specifications; an object metadata schema containing semantic metadata; and, ontology templates defining object classes for machine readable data concepts.

### B. Computer

The computer contains a display and software logic allowing a user to edit and manage key data integration and data quality information. It contains client-side software logic to manage data handling, object structure and values, user security and object access control, and object and data presentation.

The Computer (100) includes a Display (101) which can be any type that shows images and text to a user. The preferred embodiment uses a web browser application. The computer processes software programs that include: Object Logic (102); Display Logic (103); Data Handling Logic (104); and Security Logic (105).

The Computer's Object Logic (102) controls the structure, format, and values of the data objects used in the system. This logic implements system functions for manipulating, transforming, editing, and maintaining all data objects for semantically unifying data and administering the system according to the data models and metadata schemas. One function of this logic is transforming data received from the user as new or modified semantic data into a software data object for the appropriate type including knowledge, ontology, rules, and metadata types among others. Another of its functions is checking for valid values and relationships among data elements and objects. Another function is to respond to the user's request to change the status of a data object within the system between predefined workflow states of editing, reviewing, approving, and publishing.

The Computer's Display Logic (103) provides functions to format and transform data into human readable forms shown on the Display (101). This includes setting the wording, font, size, shape, position, and color of text. It also includes setting the size, color, and position of graphic images on the display. It also includes receiving input actions from the user which are converted into internal software function event requests that are further processed by other software logic components. One such event is a user request to view Rule Dictionary (300) objects. This user request is received by the Display Logic (103) which then sends an internal request to the Security Logic (105) component to determine if the user has the correct access control rights to view the objects. If the user does not pass the security check, a response is sent back to the Display Logic to show the failed request to the user on the Display (101).

The Computer's Data Handling Logic (104) provides functions for managing the data objects and changing their values and structures from entries made by the user through the Display (101) and Display Logic (103), and from data received from the Server (150). It also provides functions for collating and formatting data for sending and receiving streams of data over the Network Connection (135) for transfer to and from the Server (150). The preferred embodiment uses the JavaScript Object Notation (JSON) as the data format for transfer over the Network Connection (135) as a small-load highly efficient industry standard structure. The Data Handling Logic component converts data between the JSON format and data object structures.

The Computer's Security Logic (105) provides functions for controlling the user's access to data based on their individual roles and security clearance in each domain assigned to the semantic data objects. One function is to restrict the ability to edit data objects to only those users having the role of editor for the domain assigned to the data object. If the user does not have the proper role, a message is sent to the Display Logic (103) of the failure which is then shown on the Display (101). Another function is to control the user's ability to change the status of a data object within the system between predefined workflow states of editing, reviewing, approving, and publishing.

### C. Network Connection

The Network Connection provides electronic communication between the Computer and the Server. It uses the Hypertext Transport Protocol (HTTP) and secure HTTP (HTTPS) over telecommunication conduits to send and receive commands and data in industry standard interoperable formats.

The Network Connection (135) provides electronic communication between the Computer (100) and the Server (150). In the preferred embodiment, it uses the Hypertext Transport Protocol (HTTP) and secure HTTP (HTTPS) over telecommunication conduits to send and receive commands and data in industry standard interoperable formats.

### D. Server

The Server includes several software logic components to provide system functions. These include: Data Integration Logic; Security Logic; Data Access Logic; Data Quality Logic; and, Metadata Access Logic.

The Server (150) includes several software logic components to provide system functions. The Server's Data Integration Logic (151) provides functions for transforming data from source systems into new elements for the unified data model according to the rules and values defined in the Semantic Framework (200) products. These functions include receiving data from the Computer (100) and processing it to check accuracy and conformance to the unified data model and to the appropriate object schema. One example of this is receiving a modified Data Dictionary (600) from the Computer (100) and reviewing all of its data and the relationships among the data elements to ensure they conform to the data dictionaries schema.

The Server's Security Logic (152) provides functions for controlling the user's access to data based on their individual roles and security clearance in each domain assigned to the semantic data objects. One function is to restrict a user's access to data objects to only those they have an approved role for in the domain assigned to the data object. If the user does not have the proper role, the data object is removed from the data set sent to the Computer (100). Another function is to control the user's ability to change the status of a data object within the system between predefined workflow states of editing, reviewing, approving, and publishing.

The Server's Data Access Logic (153) provides functions for collating and formatting data for getting and sending data to the Storage device (180), and sending and receiving streams of data over the Network Connection (135) for transfer to and from the Computer (100). This logic includes converting a request for data received from the Computer (100) into the proper system commands to open and read data files or obtain data from a database on the Storage device (180). It also includes converting data received from the Computer (100) into the proper format for data files or database on the Storage device (180). The preferred embodiment uses JSON as the data format for transfer over the Network Connection (135) as a small-load highly efficient industry standard structure. The Data Access Logic component converts data between the JSON format and data file and database record formats.

The Server's Metadata Access Logic (154) provides functions for collating and formatting metadata for getting and sending data to the Storage device (180), and sending and receiving streams of data over the Network Connection (135) for transfer to and from the Computer (100). This logic includes converting a request for metadata received from the Computer (100) into the proper system commands to open and read metadata files or obtain data from a database on the Storage device (180). It also includes converting metadata received from the Computer (100) into the proper format for files or database on the Storage device (180). The preferred embodiment uses JSON as the data format for transfer over the Network Connection (135) as a small-load highly efficient industry standard structure and Extensible Markup Language (XML) as the metadata file format.

The Server's Data Quality Logic (155) provides functions for transforming the values of data from source systems into new values for the unified data model according to the rules and values defined in the Semantic Framework (200) products. These functions include receiving data from the Computer (100) and processing it to check each element's value for accuracy. One example of this is receiving a modified Data Dictionary (400) from the Computer (100) and reviewing the vocabulary assigned to its data elements to ensure they conform to the Rule Dictionaries (300) created by users and stored on the system.

### E. Storage

The Storage element provides physical storage of data and metadata. It uses data files in multiple formats and database applications. It uses multiple hard disk drives, as well as other storage formats for archiving data such as tape and optical drives.

The Storage (180) element provides physical storage of data and metadata. It uses data files in multiple formats including XML, ASCII text, binary, PKZip, Microsoft Office (Word, Excel, and PowerPoint), Adobe PDF, and HTML among others. It uses database applications like Oracle Database and Microsoft SQLServer. It uses multiple hard disk drives, as well as other storage formats for archiving data such as tape and optical drives.

### F. Semantic Framework

The semantic framework contains and connects a domain's knowledge, ontologies, rules, and semantic metadata. The ontologies represent the knowledge. The ontologies contain concepts distilled into a set of business and technical rules. The rules are expressed in English grammar. The knowledge, ontologies, and rules specify semantic metadata schema and vocabularies to annotate data.

The semantic framework (200) specifies a domain's knowledge (210), ontologies (220), rules (230), and semantic metadata (240) and links them together with direct traceable relationships. The direct linkage of each of the four major components enables facile definition and maintenance of the specification. The semantic framework defines the meaning of each component and the relationship between components using standard terminology and common phrases drawn from industry and Government publications deemed trustworthy by industry trade groups. This provides a common meaning to the components applicable to all domains. The domain knowledge (210) contains the main facts and trusted information within the domain relevant to business and operational activities pursued by the members of the domain. This knowledge is the basis for defining the other three components of the semantic framework. The knowledge originates from publications deemed trustworthy and accurate by the members of the domain, and from subject matter experts within the domain. It is documented in written form as part of the semantic framework products used in the system's processing and stored as a data file in the system. The knowledge is used to define ontologies (220) that represent the main concepts. They are documented in written form as part of the semantic framework products used in the system's processing and stored as a data file in the system. The concepts in the ontologies are the basis of business and technical rules (230) distilled from the ontologies as constraints and assertions. These are expressed in standard English grammar as a sentence composed of an optional conditional portion and a mandatory declaration portion. Using standard English grammar provides a consistent, uniform, and common form suitable for all domains and machine processing. They are documented in written form as part of the semantic framework products used in the system's processing and stored as a data file in the system. Semantic metadata (240) schema and vocabularies are defined to represent the knowledge, ontologies, and rules by annotating data with metadata attribute values. The schema are drawn from industry and Government publications deemed trustworthy by industry trade groups. This provides common semantic metadata schema with controlled vocabulary values for the metadata elements specified by the domain's knowledge, ontologies, and rules. They are documented in written form as part of the semantic framework products used in the system's processing and stored as a data file in the system.

### G. Rule Dictionary

The Rule Dictionary provides a structured format and syntax for business and technical rules that is both human-understandable and machine-readable. It allows the system to automatically read, parse, and execute the rules in software modules.

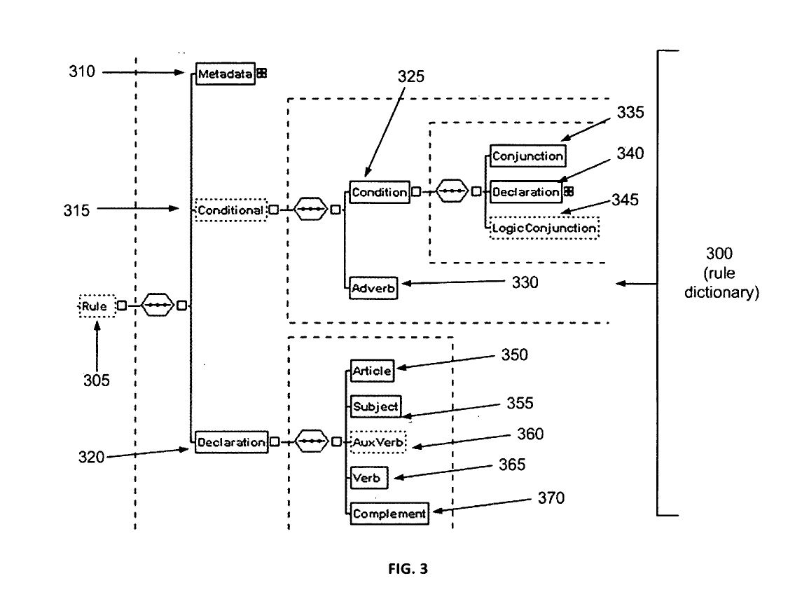

The Rule Dictionary (300) contains a set of defined data elements organized in a hierarchical manner as shown in FIG. 3. This structured format and syntax forms its schema. The schema enables consistent, repeatable, and automated Data Unification System (100) operations on the rules including displaying, editing, validating, and transforming. The schema contains multiple important sub-elements. The Metadata (310) sub-element provides the function to annotate each Rule (305) with semantic information enabling linkage to the domain's knowledge and ontologies and accurate processing by the systems' software logic. Each Rule (305) is comprised of an optional Conditional (315) section and a mandatory Declaration (320) section. The Conditional is comprised of one or more Condition (325) elements and one Adverb (330). The Condition is comprised of a Conjunction element (335), Declaration section (340), and an optional LogicConjunction (345) element. The Declaration (320) section is comprised of an Article (350) element, a Subject (355) element, an optional AuxVerb (360) element, a Verb (365) element, and a Complement (370) element. The Declaration (340) element has the same sub-elements as the Declaration (320) element. This schema uses English grammar as its structure to provide dual functionality for intuitive human-understanding and machine-readability. An example of Metadata (310) is using the industry standard Dublin Core schema with its elements for title, creator, and publisher among others. An example of a Condition (325) is: Conjunction (335) of “If”; and, Declaration (340) of “the mortgage payment is late”. An example of a Conditional (315) is: Condition (325) of “If the mortgage payment is late”; and, Adverb (330) of “then”. An example of a Declaration (320) is: Article (350) of “A”; Subject (355) of “loan officer”; AuxVerb (360) of “should”; Verb (365) of “call”; and, Complement (370) of “the mortgagee to arrange payment”. This yields for a Rule (305): “If the mortgage payment is late then a loan officer should call the mortgagee to arrange payment”. The Rule Dictionary (300) is stored as a XML file on the Storage (180) device.

### H. Data Dictionary

The Data Dictionary provides a structured format and syntax for data element definitions as a data model that is both human-understandable and machine-readable. It allows the system to automatically read, parse, and use the data in software modules.

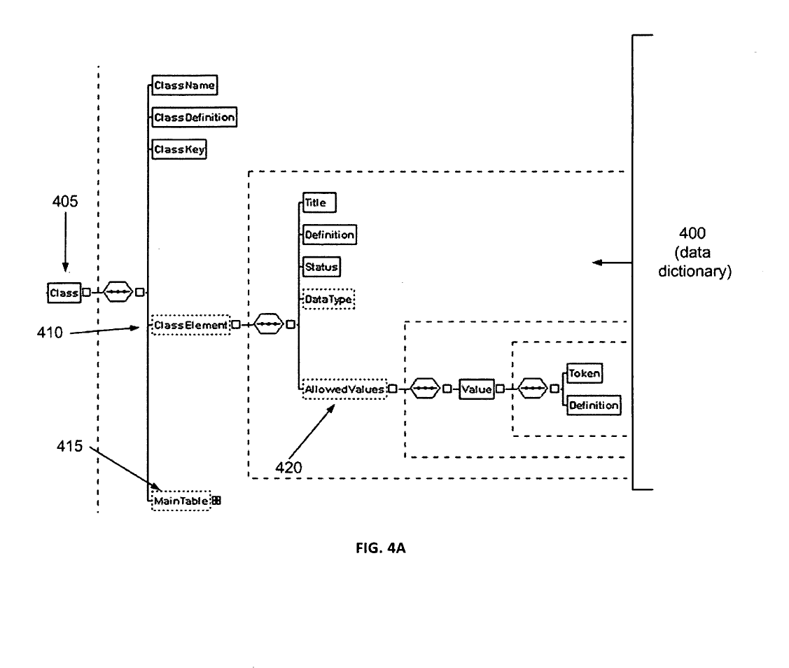

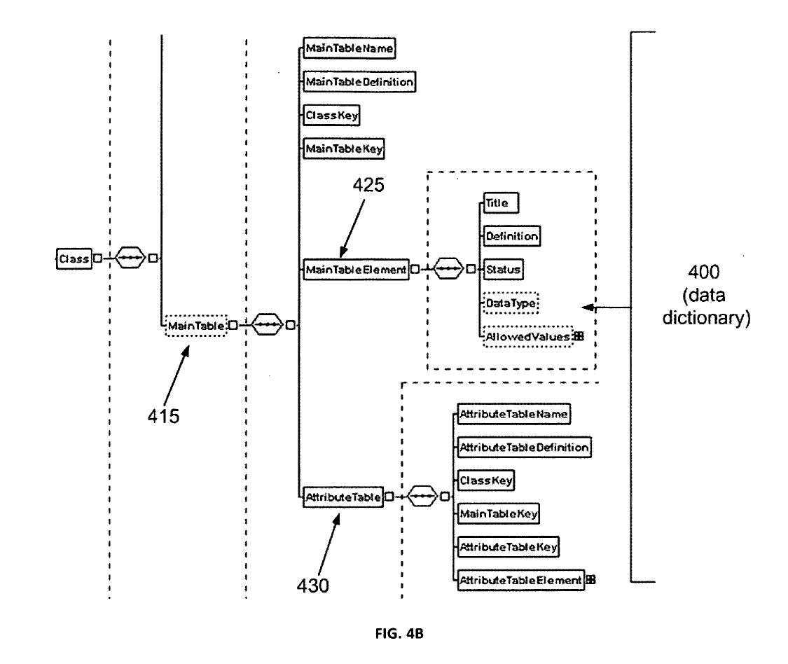

The Data Dictionary (400) contains a set of defined data elements organized in a hierarchical manner as shown in FIGS. 4A and 4B. This structured format and syntax forms its schema. The schema enables consistent, repeatable, and automated Data Unification System (100) operations on the rules including displaying, editing, validating, and transforming. The schema contains multiple important sub-elements. The Class (405) data element is the main parent element in a Data Dictionary. It is comprised of several child data elements as shown in FIG. 4A. One of its child data elements is the ClassElement (410) which is itself comprised of several child data elements. One of its child data elements is AllowedValue (420) which provides the function of allowing a specific controlled vocabulary to be specified for each data element to enable semantically mapping source data to the unified model, and data integration and data quality functions to be automatically performed in the Data Unification System (100). The Class data element also has a child of MainTable (415) which has several child data elements as shown in FIG. 4B. One of these child data elements is the MainTableElement (425) which has the same child data elements as the ClassElement (410). The MainTable also has a child AttributeTable (430) which has several child data elements. The Data Dictionary (400) is stored as a XML file on the Storage (180) device.

### I. Object Metadata Schema

The Object Metadata Schema provides a structured format and syntax for annotating data objects with semantic metadata in a consistent and interoperable manner.

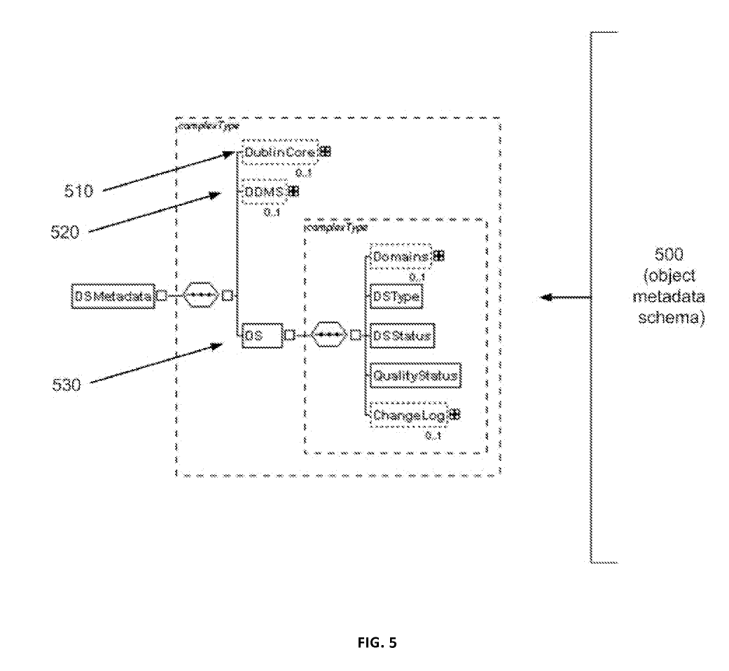

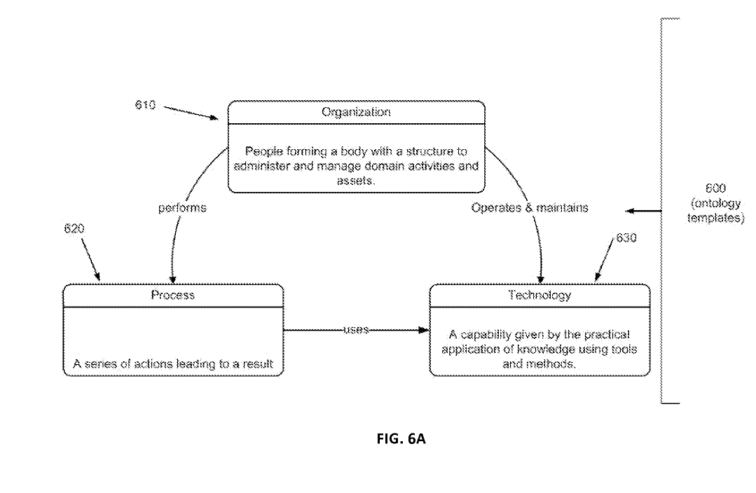

The Object Metadata Schema (500) contains a set of defined metadata elements organized in a hierarchical manner as shown in FIG. 5. This structured format and syntax forms its schema. The schema enables consistent, repeatable, and automated Data Unification System (100) operations on the data objects and is the means to assign semantic metadata (240) to objects for the Semantic Framework (200). The schema contains multiple important sub-elements. The DublinCore (510) element provides the function to assign standardized metadata elements and values to the data objects using a formal industry standard (published and maintained by Dublin Core Metadata Initiative at http://dublincore.org). The DDMS (520) element provides a similar function as DublinCore but for standard metadata elements and values for the US Department of Defense (published and maintained by US DoD CIO at http://metadata.dod.mil/mdr/irs/DDMS/). The DS (530) element provides the function for semantic metadata for the Semantic Framework (200) distinct from industry and government standards. Examples of metadata elements in DS are to describe the business domains, data quality level, and data object types. The Object Metadata Schema (500) is stored as a industry standard XSD file on the Storage (180) device.

### J. Ontology Templates

The ontology templates provide pre-built object classes to define the domain's knowledge in a consistent set of concepts across domains and user groups. They are stored in structured machine readable data files. The ontology templates are defined for three main conceptual areas common to all domains: organization; process; and technology.

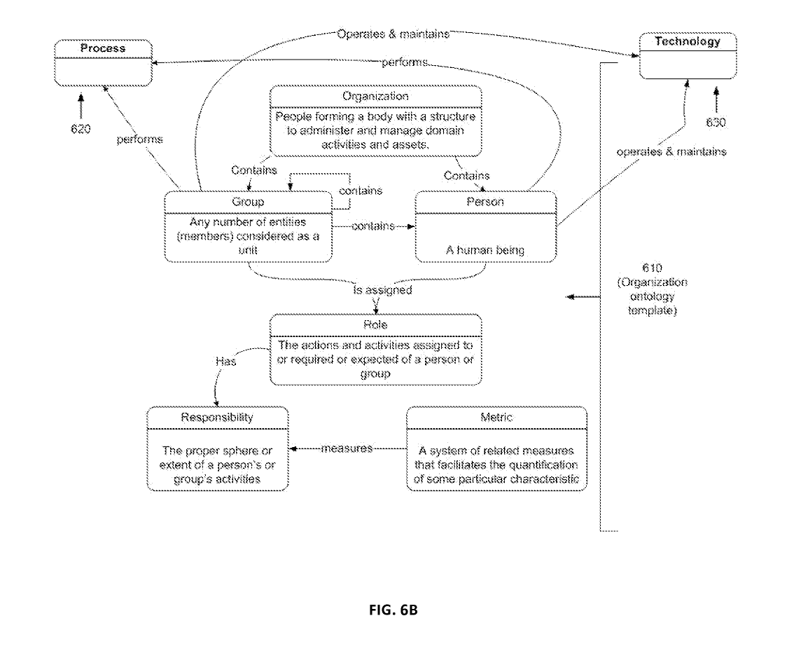

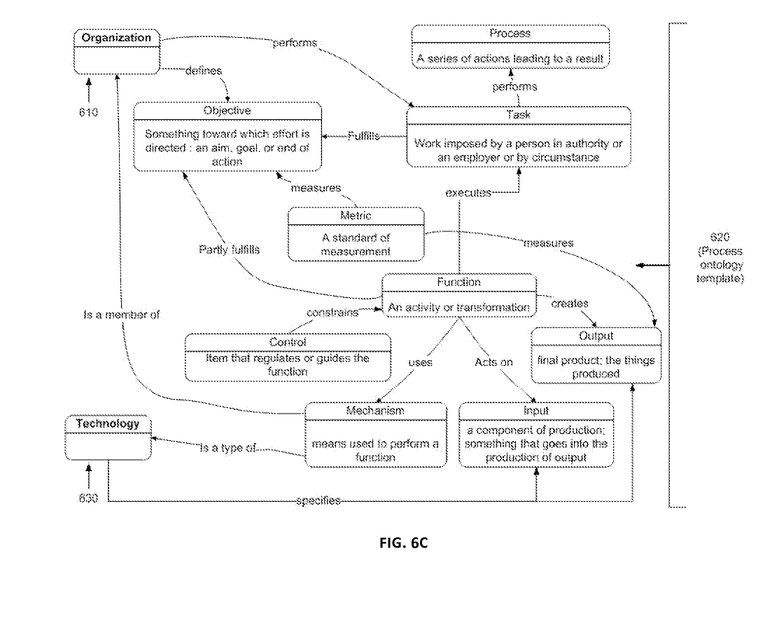

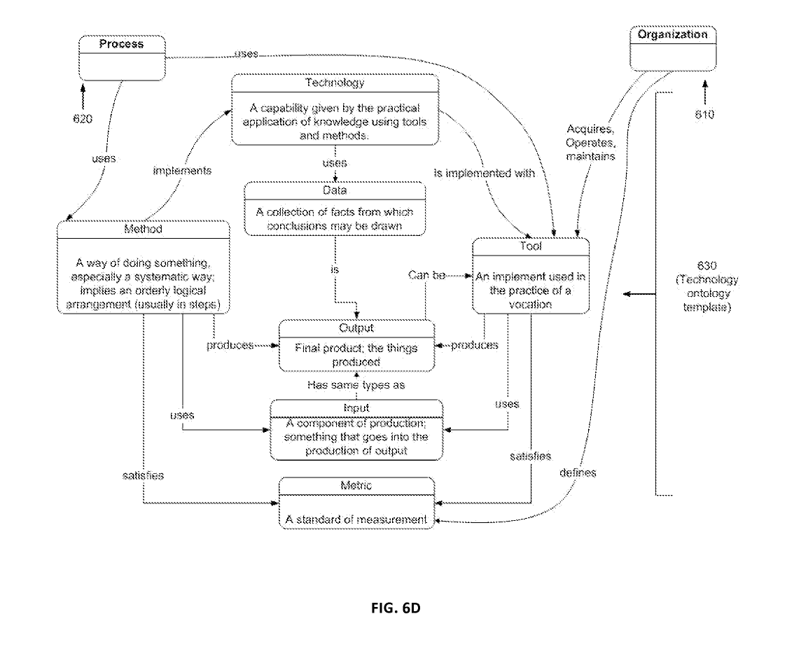

The ontology templates (600) provide pre-built conceptual models of major domain concepts organized into intuitive categories. The preferred embodiment uses categories for Organization (610), Process (620), and Technology (630) because of their widespread use in business and technical models and systems as shown in FIG. 6A. Each category is described using common definitions from standard modern English language dictionaries. Each category defines a sub-ontology template used to specify concepts within the meaning of that category. Each category is related to the other categories with a formal relationship. Each category template defines a set of object classes that are the basis of creating instance versions for a given domain. Multiple instances of each class can be created within a single sub-ontology instance and multiple sub-ontology instances can be created for a domain. The classes in the Organization (610) sub-ontology are shown in FIG. 6B. It includes classes for the most common concepts pertaining to an organization extracted from industry studies and standard data models. Each class has a definition and relates to other classes to explicitly specify its meaning within the scope of the sub-ontology. The classes in the Process (620) sub-ontology are shown in FIG. 6C. It includes classes for the most common concepts pertaining to a business process or operational activity extracted from industry studies and standard data models. Each class has a definition and relates to other classes to explicitly specify its meaning within the scope of the sub-ontology. The classes in the Technology (630) sub-ontology are shown in FIG. 6D. It includes classes for the most common concepts pertaining to technology owned and maintained by organizations and used in business processes and operational activities extracted from industry studies and standard data models. Each class has a definition and relates to other classes to explicitly specify its meaning within the scope of the sub-ontology.

An alternative structure of the ontology templates can use other primary categories to separate domain concepts into consistent, reusable groups. These categories can be synonyms of the preferred embodiment categories. Another alternative structure of the sub-ontologies is to use conceptual or logical data models to represent the concepts instead of the object classes. The conceptual or logical data models can use the same, similar, or different names for their concepts as long as the same functionality of separating major domain concepts into consistent and reusable subgroups is followed. For the Organization category, suitable alternatives can be: group; association; institute; business; company; corporation; and enterprise among others. Within this sub-ontology, other classes can be defined and added to the existing classes or used to replace existing classes representing major concepts of the organization, or its alternative name. For the Process category, suitable alternatives can be: procedure; course; method; manner; means; progression; and course-of-action among others. Within this sub-ontology, other classes can be defined and added to the existing classes or used to replace existing classes representing major concepts of the organization, or its alternative name. For the Technology category, suitable alternatives can be: tool; system; machine; and data among others. Within this sub-ontology, other classes can be defined and added to the existing classes or used to replace existing classes representing major concepts of the organization, or its alternative name.

### K. Operation of Preferred Embodiment

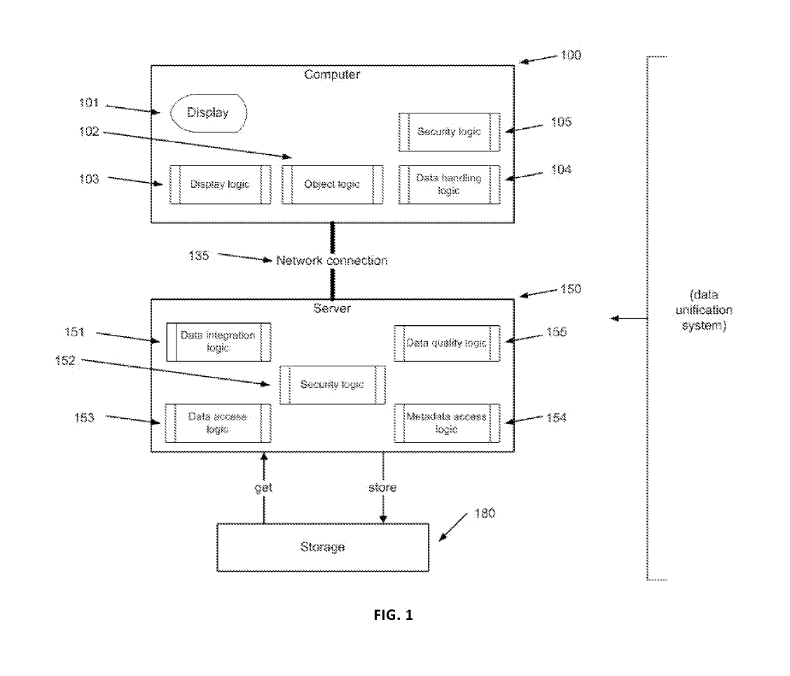

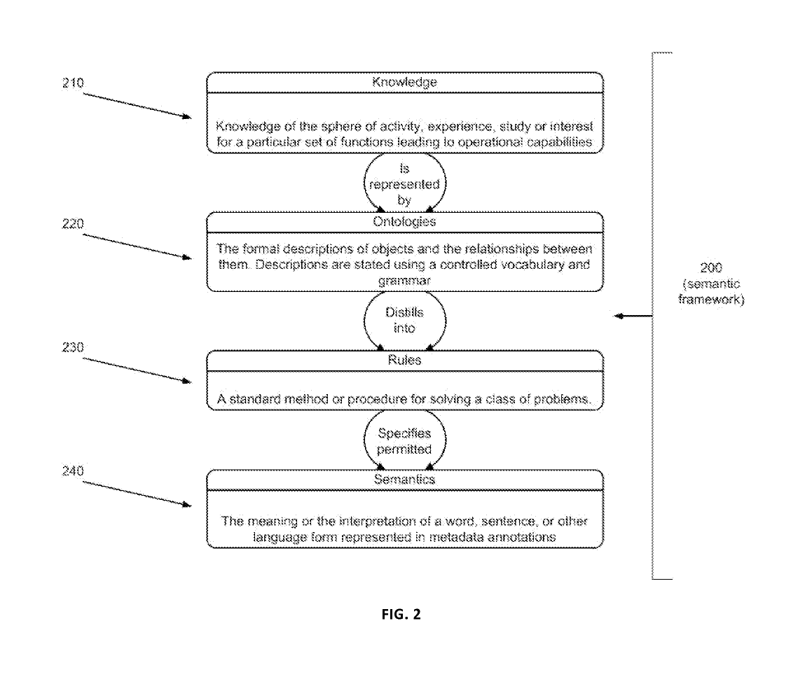

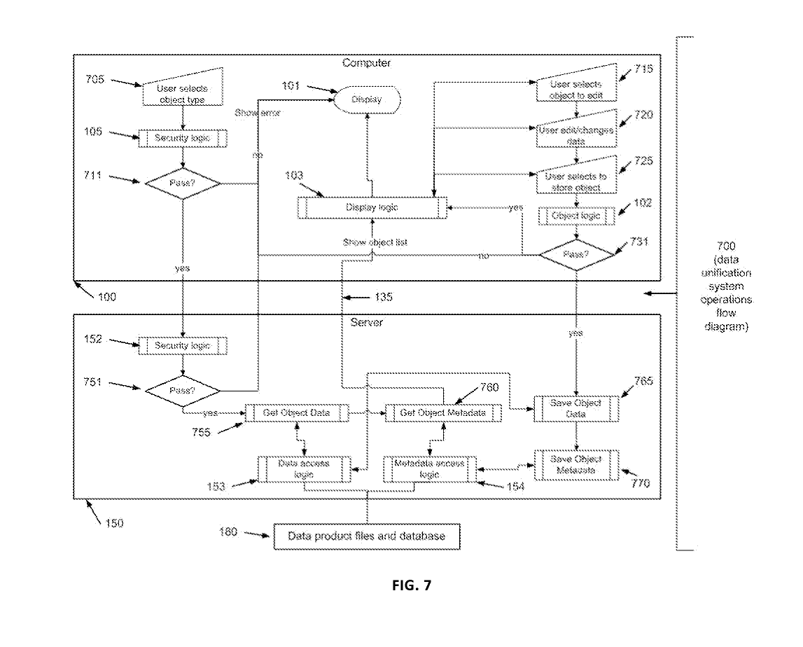

The preferred embodiment collects, edits, manages, and stores data and metadata for data unification using the system functions provided by the components shown in FIGS. 1-6 and according to the system operation flow chart shown in FIG. 7.

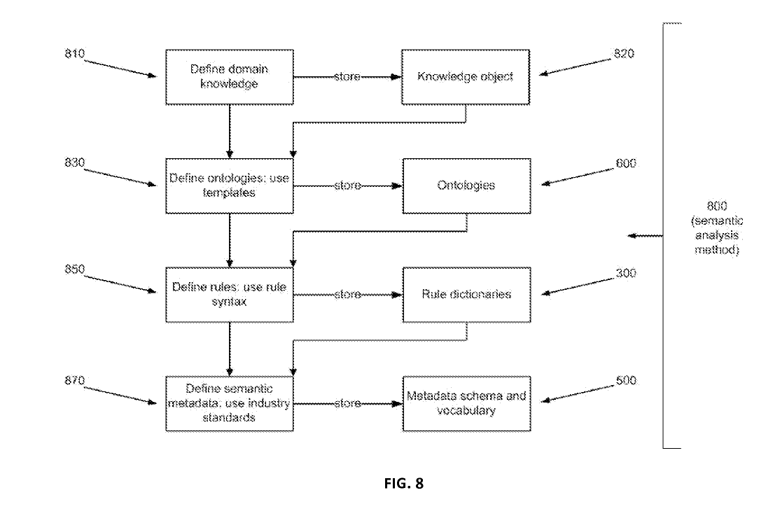

The overall operation proceeds according to Semantic Analysis Method (800) shown in the flow chart in FIG. 8. A user performs the process step to Define Domain Knowledge (810) by collecting published documents from the domain, investigating open sources of information like Internet web pages and repositories, and communicating with subject matter experts. The user analyzes this information and creates a Knowledge object (820) which is entered into the system. The Knowledge object is used as a source of authoritative knowledge on the domain's key ideas, concepts, and terminology for the process step to Define Ontologies (830). In this step, a user creates ontologies in the system using the Ontology Templates (600) by correlating domain knowledge with the ontology classes and creating instances of an ontology class for each domain concept deemed important and relevant enough to be included in the ontologies. These ontologies are used as the source of authoritative concepts, entities, and related process activities from which rules are extracted in the process step Define Rules (850). The rules include business and technical rules. A user analyzes the ontologies and extracts rules that are put into the syntax of Rule Dictionaries (300) which are entered into the system. The final step of the semantic analysis process is Define Semantic Metadata (870). In this process step, a user analyzes the rules to extract the key characteristics of the data, rules, ontologies, and knowledge that need to be represented in the continuous data operations to accurately unify the domain's data. The user collects relevant industry standards, such as Dublin Core, as the basic metadata schemas and extends them as required to include metadata elements and element vocabularies. The user creates the Metadata Schema and Vocabulary (500) which are entered into the system.

The system operates according to the flow chart shown in FIG. 7. A user interacts with the computer (100) using a web browser that displays information and graphics and accepts and processes user input events. In one use of the system, a user selects the type of content (705) object they wish to view or edit from a menu. This request is passed to the Security Logic (105) component on the client computer operating within the web browser. This component checks (711) the user's credentials and access privileges to determine if they are permitted to access this function and content object type. If they are not permitted an error message is shown on the Display (101). If they pass the security check, the request is sent to the Server (150) over an Internet connection (135). The request and user data are processed by the Server's Security Logic (152) which checks (751) the user's security and domain privileges again to ensure that no unauthorized requests were inserted into the transmission from the Computer. If the check fails, an error message is sent back to the Computer (100) over the Network Connection (135) and is displayed on the Display (101) so the user can see the reason for the failure. If the check passes, the request is sent to the Get Object Data (755) function. This function calls the Data Access Logic (153) component which formulates the proper command syntax and retrieves the list of content objects and their content data for the request type from the content storage repository (180). Next, the metadata for each object in the list is retrieved by the function Get Object Metadata (760) which calls the Metadata Access Logic (154) component. This component formulates the proper command syntax to retrieve the metadata from the metadata storage repository (180). The metadata uses the Object Metadata Schema (500) which is compared to the user's access privileges to filter the list of content objects to other those having security classification and domain status acceptable to the user's credentials. The final set of content object data is sent back to the client Computer (100) over the Network Connection (135). It is received by the client-side Display Logic (103) component which constructs the appropriate text and graphics presentation to show on the Display (101).

With this list shown to the user, the user selects an object to edit (715). The system constructs the proper display for the content object data using the Display Logic (103) client-side component. The data is organized according to the schema for its type such as Data Dictionary (400) or Rule Dictionary (300) among others. The user makes changes to the data (720) and then selects to store the new data (725). This request is sent to the Computer's Object Logic (102) which validates the modified data to the appropriate schema and performs checks on data values (731). If the object fails this check, an error message is displayed to the user on the Display (101). If the object passes the check, the new data is sent to the Server over the Network Connection where it is received by the Server's save Object Data (765) function. This function constructs the proper data structure and syntax for the Data Access Logic (153) component which transforms the data into the final storage structure according the appropriate schema and storage format. The data is then saved on the storage device (180). Next, the object's updated metadata is put into the proper structure and syntax by the Save Object Metadata (770) function for the Metadata Access Logic (154) component which transforms the metadata into the final storage structure according the appropriate schema and storage format. The metadata is then saved on the storage device (180). The system is then available for another user selection.

### L. Alternative Embodiments of Invention

The preferred embodiment uses several key components as shown in FIGS. 1-6. Many alternate structures are possible with different combinations of component structures and functions. These can be used for the invention as long as the overall system structure and function provides functions to unify disparate data into a unified semantic framework. Additional detail on some possible variations of each component is provided in the following paragraphs.

Several alternate structures of the Computer (100) are possible. A few examples are a network appliance, cellular phone, and handheld computer. A network appliance is a device sold as a web-based thin client with very little local processing power and storage capacity. It runs a web browser and connects via the Internet to a web server at a remote location that processes most or all software logic and stores data. Cellular phones are increasingly supplied as small computer devices with web browsers capable of operating in the same manner as the network appliance. A handheld computer is a small computer intended for mobile users but having a display, computer processor, and local storage. In each case, the devices supply the required Computer functions as long as they are able to display text and graphics to the user, accept commands from the user, execute local software functions, and communicate with a remote server over a network connection. Another alternate structure is a single computing system that operates both the Computer and the Server functions.

Several alternate structures and functions of the Computer's software logic are possible. The software logic components can be downloaded from the server as executable applets, such as Java applets, either when the initial connection is made between the Computer and Server, or when the function provided by the logic module is first used. The logic modules can be organized into a greater or fewer number of logic modules as long as all functions are provided by the combined aggregate software. The functions of the logic modules can be supplied by other software or hardware components of the Computer. An example of this alternate functionality is on a cellular phone where a hardware device might handle Display Logic (103) or Security Logic (105) for faster processing or lower power consumption.

Several alternative structures of the Network Connection (135) are possible. One alternate structure is a direct connection between the Computer (100) and Server (150) with a wired or wireless protocol. Examples of direct connections are cables using USB, 1394, or Ethernet. Examples of wireless connections are Bluetooth and Wi-Fi (IEEE 802.11 specification). Another alternate structure is a hardware board connecting one or more processors together with one or memory devices. An example of this structure is a multi-CPU electronic board with conducting lines providing communication signals between the CPUs directly or indirectly through an intermediate device.

Several alternate structures of the Server (150) are possible. A few examples are cloud computing, cellular phone, and handheld computer. Cloud computing entails using computer resources distributed over a network in an integrated and virtual manner such that the user and Computer do not know which physical server is processing their requests. Cellular phones are increasingly supplied as small computer devices with web browsers capable of operating in the same manner as the network appliance. A natural progression of the technology is for some cellular phones to have significant amounts of computational power and local storage, similar to current mobile digital music playing devices. A handheld computer is a small computer intended for mobile users but having a display, computer processor, and local storage. In each case, the devices can supply the required Server functions as long as they are able to execute software functions, transfer data to and from a storage device either local or remote, and communicate with a remote Computer over a network connection. Another alternate structure is a single computing system that operates both the Computer and the Server functions.

Several alternate structures and functions of the Server's software logic are possible. The software logic components can be downloaded from the server as executable applets, such as Java applets, either when the initial connection is made between the Computer and Server, or when the function provided by the logic module is first used. The logic modules can be organized into a greater or fewer number of logic modules as long as all functions are provided by the combined aggregate software. The functions of the logic modules can be supplied by other software or hardware components of the Computer. An example of this alternate functionality is on a cellular phone where a hardware device might handle Display Logic (103) or Security Logic (105) for faster processing or lower power consumption.

Several alternate structures of the Storage (180) are possible. An alternate structure is the storage device integrated with Server (150). In this structure, the storage media will be components of the Server. Another alternate structure is cloud computing storage where the physical storage location and media type is unknown and accessed via a network connection. Another alternate structure is holographic media where the data is stored in holographic images rather than files on magnetic media.

Several alternate structures of the Semantic Framework (200) are possible. An alternative structure of the semantic framework can organize the domain data and describe its underlying context and definitions in one or more components that together describe in detail the domain's knowledge, concepts and ontologies, rules, and metadata. This can be organized as a combination of conceptual, logical and physical data models, ontology files, rule files, and metadata schema. An alternative structure can use components with synonymous names for the same functionality. For the knowledge component (210), several products are produced in the fields of Knowledge Management and Knowledge Engineering that provide the same functionality of documenting a domain's knowledge. These products typically include knowledge handbook, stories, knowledge maps, community of practice or interest discussions and documents, lessons learned, and frequently asked questions among others. These can all be used for the knowledge component of the semantic framework as long as they describe a domain's knowledge clearly and are stored in the system. For the ontology (220) component, several products are produced in the fields of ontology engineering, data modeling, and semantic analysis that provide the same functionality. These products include ontologies, conceptual models, and logical models among others. These can all be used for the ontology component of the semantic framework as long as they describe a domain's concepts clearly and have direct traceability to the knowledge component and are stored in the system. For the rules (230) component, several products are produced in the fields of business rules, model-driven software, Enterprise Architecture, and rule engines that provide the same functionality. These products include rule schema, facts, assertions, inference models, relational models, Business Process Execution Language (BPEL) files, and Business Process Models (BPM) among others. These can all be used for the rules component of the semantic framework as long as they define a domain's business and technical rules clearly in structured syntax with direct traceability to the knowledge and ontology components and are stored in the system. For the semantics (240) component, several products are produced in the fields of metadata, Semantic Web, data registries and repositories, web services, messaging, and data modeling that provide the same functionality. These products include metadata schema, vocabularies, dictionaries among others. These can all be used for the semantics component of the semantic framework as long as they define describe a domain's semantic metadata clearly in structured syntax and formats with direct traceability to the knowledge, ontology, and rules components and are stored in the system.

Several alternate structures of the Rule Dictionary (300) can be used. For the schema, there are industry standards available that can be used to express the rules. These include Business Process Execution Language (BPEL) and Semantics of Business Vocabulary and Business Rules (SBVR). These structures can provide the same functionality as long as the rules are expressed in clear unambiguous statements. The Rule Dictionary file can be in other formats including delimited ASCII text, binary, JSON, spreadsheet, and word processor among others. It can also be stored in a database as a set of records.

Several alternate structures of the Data Dictionary (400) can be used. For the schema, there include relational, object, and entity-attribute data models. These structures can provide the required functionality as long as their schema have data elements where vocabulary values can be saved to enable semantically mapping source data to the unified model. The Data Dictionary file can be in other formats including delimited ASCII text, binary, JSON, spreadsheet, and word processor among others. It can also be stored in a database as a set of records.

Several alternate structures can be used for the Object Metadata Schema (500). One example is to use only a published standard such as Dublin Core or DDMS. Another example is using only a custom schema like DS. Any combination of standard and custom schemas can be used as long as they provide the function to annotate data objects with semantic metadata according to the structure and functions of the Semantic Framework (200).

An alternative structure of the ontology templates (600) can use other primary categories to separate domain concepts into consistent, reusable groups. These categories can be synonyms of the preferred embodiment categories. Another alternative structure of the sub-ontologies is to use conceptual or logical data models to represent the concepts instead of the object classes. The conceptual or logical data models can use the same, similar, or different names for their concepts as long as the same functionality of separating major domain concepts into consistent and reusable subgroups is followed. For the Organization category, suitable alternatives can be: group; association; institute; business; company; corporation; and enterprise among others. Within this sub-ontology, other classes can be defined and added to the existing classes or used to replace existing classes representing major concepts of the organization, or its alternative name. For the Process category, suitable alternatives can be: procedure; course; method; manner; means; progression; and course-of-action among others. Within this sub-ontology, other classes can be defined and added to the existing classes or used to replace existing classes representing major concepts of the organization, or its alternative name. For the Technology category, suitable alternatives can be: tool; system; machine; and data among others. Within this sub-ontology, other classes can be defined and added to the existing classes or used to replace existing classes representing major concepts of the organization, or its alternative name.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. A method of semantically unifying data from multiple disparate sources into a common semantic framework, said method comprising the steps of:
a. Defining knowledge objects KO representing the domain knowledge of a particular business domain;
b. Defining ontologies O representing the important concepts and interrelationships of the set of knowledge objects for a particular business domain;
c. Defining rules R representing the facts and required logic explicit and implicit in the ontologies for a particular business domain;
d. Defining semantic metadata SM representing the rules, ontologies, and knowledge objects of a particular business domain;
e. Linking the knowledge objects KO, ontologies O, rules R, and semantic metadata SM together in a unified semantic framework SF with explicit mapping of entities among each component;
f. Defining common data models CDM derived from the concepts represented in the ontologies O in an object-oriented software class structure;

2. The method of claim 1, wherein said ontologies O are defined with steps of:
a. Selecting primary ontology concepts from a template of predefined classes comprising common organizational, technological, and process terminology;
b. Creating instances of primary concept classes CC and assigning each a title and definition derived from the business domain's knowledge objects KO;
c. Creating instances of relationships between instances of primary classes CC using predefined templates of relationship classes RC;

3. The method of claim 1, wherein said rules R are defined with steps of:
a. Selecting primary rule components RIC from a template of predefined classes comprising standardized English grammar sentence parts;
b. Selecting an optional conditional rule component from predefined template;
c. Adding one or more condition components to each conditional component;
d. Defining each condition using predefined templates of classes representing standardized English grammar items;
e. Defining a mandatory declaration rule component using predefined templates of classes representing standardized English grammar items;
f. Defining semantic metadata for each rule using a predefined template of one or more standard metadata schemas.

4. The method of claim 1, wherein said semantic metadata SM is defined using a predefined template of one or more standard metadata schemas.

5. The method of claim 6, wherein said semantic metadata SM is defined with steps of:
a. Selecting metadata elements ME from a predefined template representing the standard metadata schema;
b. Creating instances of each metadata element according to the metadata schema multiplicity constraints;
c. Selecting values for each metadata element from a controlled vocabulary when specified by the metadata schema;
d. Defining new values for metadata elements.

6. The method of claim 2, wherein said common data models CDM are defined with steps of:
a. Selecting data model components DMC from a template of predefined classes comprising entities in an object model;
b. Creating instances of data model class entities CE and assigning each a title and definition derived from the business domain's ontologies O and rules R;
c. Creating instances of main table MT entities within each data model class entity CE and assigning each title and definition derived from the business domain's ontologies O and rules R;
d. Defining instances of controlled vocabulary allowed value AV tokens and definitions for each main table entity MT;
e. Defining instances of controlled vocabulary allowed value AV′ tokens and definitions for each attribute table entity AT in each main table entity MT.

7. The method of claim 3, wherein said knowledge objects KO comprise multiple electronic formats readable by computer operating systems consisting of ASCII text, Extensible Markup Language (XML), PDF, Microsoft Office formats, Hypertext Markup Language (HTML), and data instance formats.

8. The method of claim 4, wherein said ontologies O comprise Extensible Markup Language (XML) files.

9. The method of claim 5, wherein said rules R comprise Extensible Markup Language (XML) files.

10. The method of claim 6, wherein said semantic metadata SM comprise Extensible Markup Language (XML) and XML Schema Definition (XSD) files.

11. The method of claim 8, wherein said common data models CDM comprise Extensible Markup Language (XML) files.

12. The method of claim 1, further comprising the step of applying computer visualization to present the semantic definitions and linkage among knowledge objects KO, ontologies O, rules R, and semantic metadata SM.

13. A computer readable medium containing program instructions and computer software that loads into a computing device enabling said device to semantically unify data from multiple disparate sources into a common semantic framework enabling said device to semantically unify disparate data models by:
a. Receiving input representing selection of knowledge objects KO;
b. Receiving input representing selection of ontology concept classes CC and relationship classes RC;
c. Receiving input representing selection of rule components RIC;
d. Receiving input representing selection of metadata elements ME;
e. Receiving input representing selection of data model components DMC;

14. The computer readable medium of claim 13, wherein said:
a. knowledge objects KO comprise multiple electronic formats readable by computer operating systems consisting of ASCII text, Extensible Markup Language (XML), PDF, Microsoft Office formats, Hypertext Markup Language (HTML), and data instance formats.
b. ontologies O comprise Extensible Markup Language (XML) files.
c. rules R comprise Extensible Markup Language (XML) files.
d. semantic metadata SM comprise Extensible Markup Language (XML) and XML Schema Definition (XSD) files.
e. common data models CDM comprise Extensible Markup Language (XML) files.

15. A computing device operable to semantically unify data from multiple disparate sources into a common semantic framework, further operable to semantically unify disparate data models by:
a. Receiving input representing selection of knowledge objects KO;
b. Receiving input representing selection of ontology concept classes CC and relationship classes RC;
c. Receiving input representing selection of rule components RIC;
d. Receiving input representing selection of metadata elements ME;
e. Receiving input representing selection of data model components DMC;

16. The computing device of claim 15, wherein said:
a. knowledge objects KO comprise multiple electronic formats readable by computer operating systems consisting of ASCII text, Extensible Markup Language (XML), PDF, Microsoft Office formats, Hypertext Markup Language (HTML), and data instance formats.
b. ontologies O comprise Extensible Markup Language (XML) files.
c. rules R comprise Extensible Markup Language (XML) files.
d. semantic metadata SM comprise Extensible Markup Language (XML) and XML Schema Definition (XSD) files.
e. common data models CDM comprise Extensible Markup Language (XML) files.

17. The computing device of claim 15, further operable to apply computer visualization to present the semantic definitions and linkage among knowledge objects KO, ontologies O, rules R, and semantic metadata SM.
